(19) United States
(12) Patent Application Publication
(10) Pub. No.: US 2019/0178344 A1
(43) Pub. Date: Jun. 13, 2019

(54) Directional Link Chain for Use in Chain Wheel Operators

(71) Applicant: Honu Management LLC, North Charleston, SC (US)

(72) Inventor: Robert Charles Kallgren, North Charleston, SC (US)

(21) Appl. No.: 15/899,221

(22) Filed: Feb. 19, 2018

Related U.S. Application Data
(63) Continuation-in-part of application No. 29/628,950, filed on Dec. 8, 2017, now Pat. No. D846427.

(51) Int. Cl. F16G 13/12; F16G 15/12

(52) U.S. Cl. CPC F16G 13/12; E06B 9/78; F16G 15/12

(57) ABSTRACT

A directional link chain includes a directional indication element configured to indicate the travel direction of chain wheel operators, such as a chain fall or roll-up door. During operation of the chain fall, for example, the directional indication element indicates the travel direction for an attached load. The directional indication element includes both a vertical and a horizontal indication for a multitude of applications. The improved link chain enables an operator to visually recognize the gear system direction and corresponding attached load direction via the directional indication element to efficiently move the attached load the desired direction without trial and error.

### CROSS REFERENCE TO RELATED APPLICATIONS

This application claims the benefit of U.S. Design patent application Ser. No. 29/628,950, filed on Dec. 8, 2017 entitled “DIRECTIONAL LINK CHAIN”, the disclosure of which is hereby incorporated in its entirety at least by reference.

### FIELD

The present disclosure generally relates to link chain; and, is more particularly directed to directional link chain for use in chain wheel operators.

### BACKGROUND

Through applied effort, ingenuity, and innovation, Applicant has identified a number of deficiencies and problems with link chain used on chain wheel operators, such as chain falls, roll-up doors, valve operators. In an example application, a chain fall, also called a chain hoist or differential pulley, is used to manually lift heavy objects by using the mechanical advantage of a gear system. When lifting heavy objects, a high amount of force is applied to a chain fall's lifting chains, which have limited tensile strength depending on the chain grade used. While operating a chain fall, an operator pulls a hand chain comprised of interconnected link chain to move the gear system, which in turn rotates the lifting chains to move a heavy object or attached load vertically or horizontally. Depending on the specific gearing of the chain fall used, it requires a tremendous amount of time to move a very heavy object a small distance. Occasionally, an operator may be pulling the hand chain in the wrong direction resulting in the load moving in the wrong direction. This could result at the very least in time consuming delays, and in some situations cause the load to be imbalanced and not level when multiple operators are used. This can be a serious problem and can create a significant safety hazard depending on the application and object lifted. Consequently, Applicant has developed a solution that is embodied by the present invention, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a directional link chain for use in chain wheel operators, such as chain falls and roll up door systems, comprising a series of interconnected directional links, each directional link comprising a first U-shaped end and a second U-shaped end forming an integral link chain, wherein the first and second U-shaped ends are opposed at a transverse plane and symmetric to a longitudinal axis; and, a directional indication element consisting of a pair of directional members, wherein each directional member of the pair of directional members includes a proximal end and a distal end, the distal ends forming at least one indication point, the directional indication element corresponding to a directionality of travel of a load during operation in a chain wheel operator.

Another object of the present disclosure is a directional link chain for use in chain wheel operators or roll-up garage door systems comprising a series of interconnected directional links, each directional link comprising at least one U-shaped end; and, a directional indication element having at least one indication point, the directional indication element corresponding to a directionality of travel of a load during operation in a chain wheel operator.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is an illustration of link chain of the prior art for use in a chain fall, according to an embodiment;

FIG. 2a is an isometric view of a directional link chain, according to an embodiment;

FIG. 2b is a front view of FIG. 2a;

FIG. 3a is a front view of a directional link chain, according to an embodiment;

FIG. 3b is a front view of a directional link chain having an alternative directional indication member, according to an embodiment;

FIG. 3c is a front view of an alternative directional link chain, according to an embodiment;

FIG. 3d is a front view of an alternative directional link chain, according to an embodiment;

FIG. 4 is an illustration of a series of interconnected directional links for use in a vertical chain fall, according to an embodiment;

FIG. 5a is an illustration of a series of interconnected directional links for use in a horizontal chain fall, according to an embodiment; and,

FIG. 5b is a front view of a directional link chain of the series of interconnected directional links of FIG. 5a.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner,” “outer,” “proximal,” “distal,” “transverse,” and “longitudinal” designate directions in the drawings to which reference is made. In addition, reference to “first,” “second,” “third,” and etc. members throughout the disclosure (and in particular, claims) are not used to show a serial or numerical limitation but instead are used to distinguish or identify the various members of the group. The word “a” is defined to mean “at least one.” The terminology includes the words above specifically mentioned, derivatives thereof, and words of similar import.

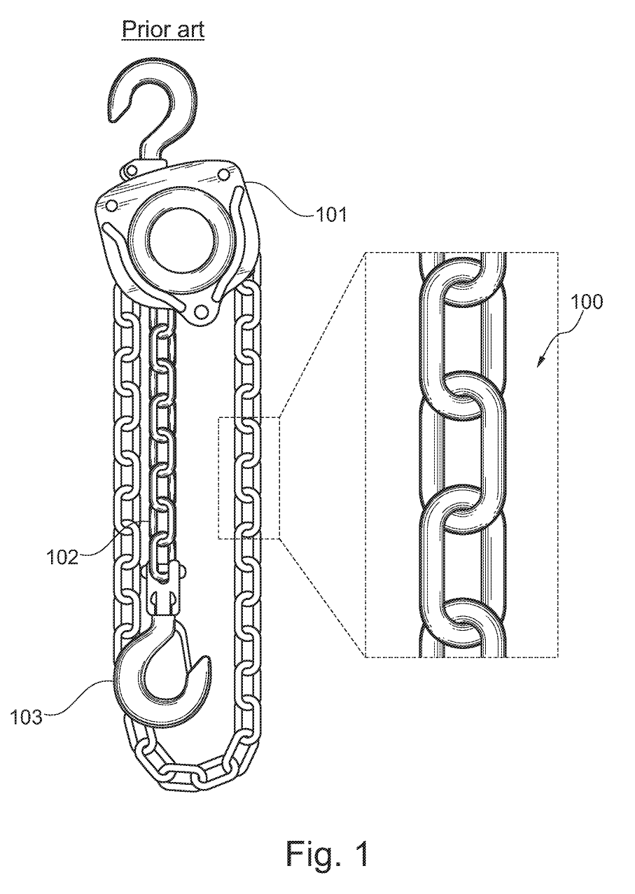

Referring now to FIG. 1, link chain 100 of the prior art for use in a chain fall or roll-up door 101 is illustrated. During operation, a user or multiple users pull link chain 100 connected to a gear system in chain fall or roll-up garage door 101 enabling lifting chain 102 and attached load via hook 103 to be moved vertically or horizontally. This is especially useful when heavy loads are required to be moved, as the mechanical advantage of the gear system allows the user or multiple users to exert less force necessary to move the heavy loads when compared to other methods. However, link chain 100 of the prior art lacks any indication of direction corresponding to the direction of the gear system and corresponding load direction. This can disadvantageously lead to users pulling the link chain, and the corresponding load, in the opposite direction as intended.

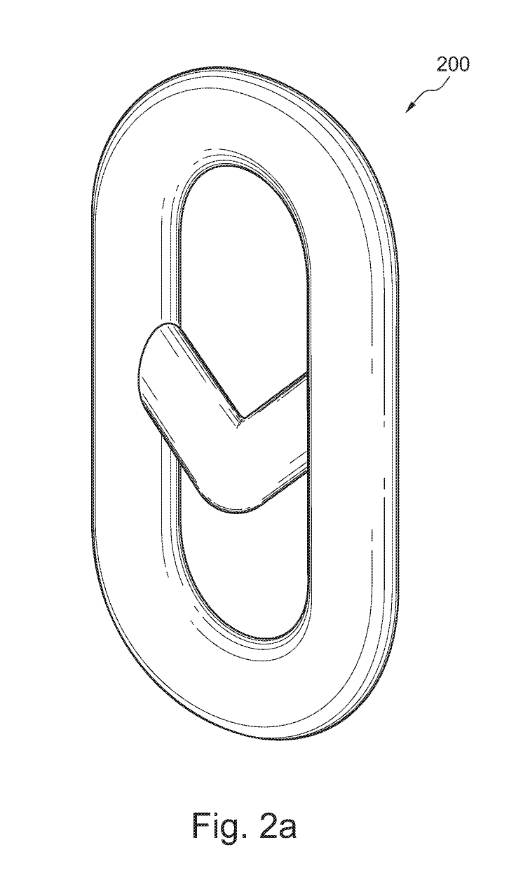

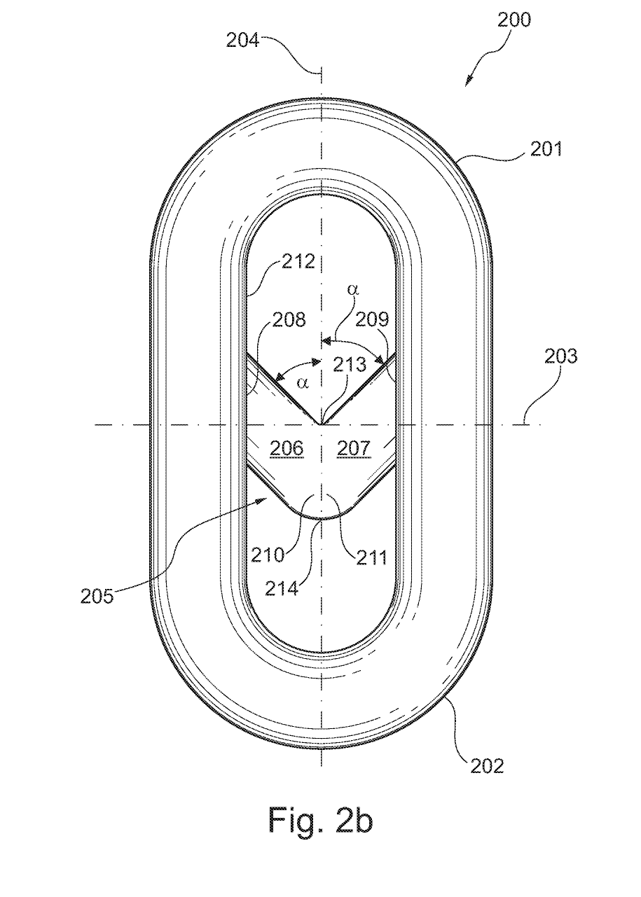

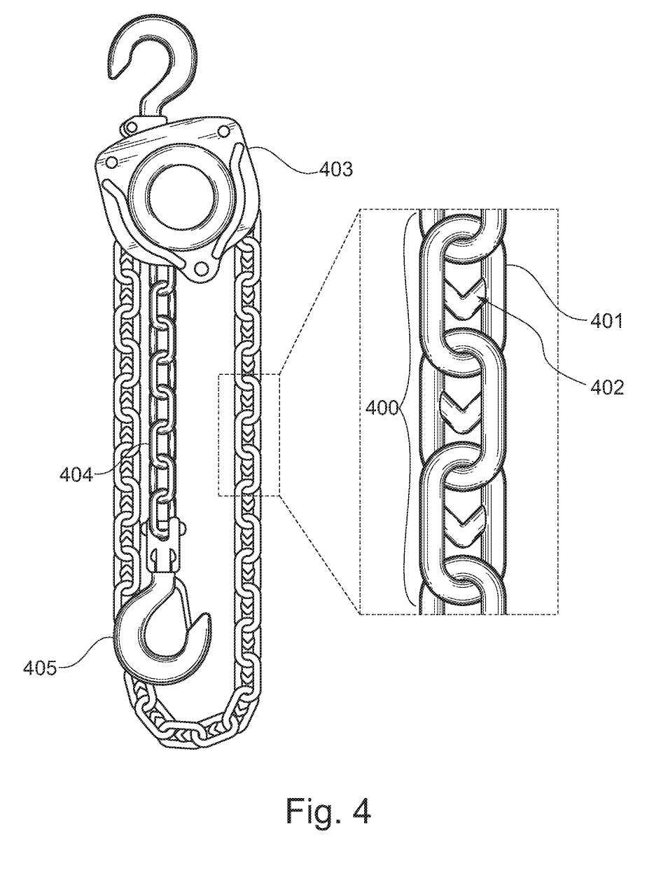

Referring now to FIGS. 2a-2b, a directional link chain 200 is illustrated. According to an embodiment, directional link chain 200 comprises a first U-shaped end 201 and a second U-shaped end 202 opposed at a transverse plane 203, such that the first U-shaped end is above the transverse plane, and the second U-shaped end is below the plane. First U-shaped end 201 and second U-shaped end 202 form an integral link chain configured to be interconnected to a series of interconnected directional links 400 (FIG. 4). In an embodiment, first U-shaped end 201 and second U-shaped end 202 are symmetric to a longitudinal axis 204.

In an embodiment, a directional indication element 205 is provided, the directional indication element consisting of a pair of directional members 206/207 each directional member having a proximal end 208/209 and a distal end 210/211. In an embodiment, the proximal end of each directional member is attached to an interior surface 212 of the integral link chain. The distal ends of each directional member are combined to form an upper indication point 213 and a lower indication point 214. The directional indication element indicates to an operator the direction of load travel for use in chain falls or similar chain driven hand crank systems. This will be discussed in further detail below.

In an embodiment, upper indication point 213 and lower indication point 214 are positioned along longitudinal axis 204. The pair of directional members is positioned symmetrically in relation to longitudinal axis 204, such that the pair of directional members forms a pair of equal acute angles α from longitudinal axis 204. Angles α define the slope of the pair of directional members of directional indication element 205. Specifically, the pair of equal acute angles α corresponds to the slope of the pair of directional members defining a V-shape of directional indication element 205. The V-shape of directional indication element 205 is recognized as an arrow, and advantageously used to show load directional travel during operation. It should be understood, that angles α may vary depending on design considerations for the directional indication element. For instance, the V-shape or arrow is easily recognizable by a user during operation, however by varying angles α, the directional indication element may cause some confusion, especially if angles α are too large, i.e. close to 90 degrees. Thus, it is critical to select angles α that avoid confusion and clearly indicate a direction via directional indication element 205, while factoring in material usage, construction, weight, and balance of the directional indication element and the direction link chain as a whole. Preferably, each angle α of the pair of equal acute angles is approximately 45 degrees.

Preferably, upper indication point 213 is positioned approximate to transverse plane 203. This ensures proper weight and balance of the directional indication element when factoring in the pair of equal acute angles α of directional members 206 and 207.

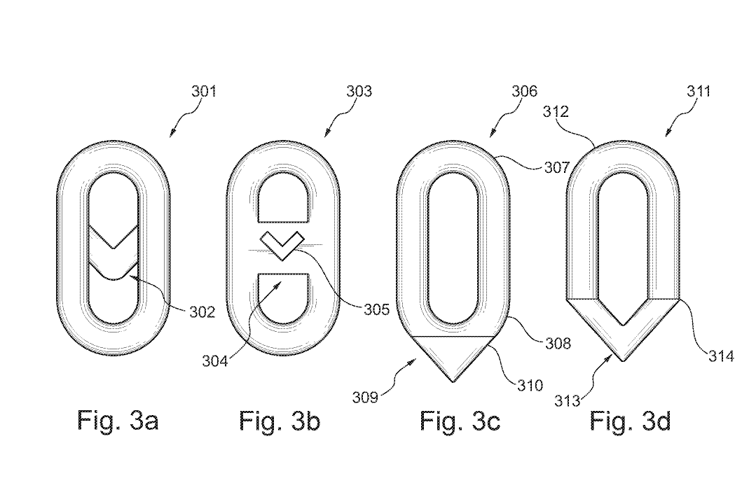

FIGS. 3a-3d are front views of various embodiments of a directional link chain. Referring now to FIG. 3a, an embodiment of a directional link chain 301 is illustrated. Directional link chain 301 comprises a directional indication element 302 having a similar structure as described above, and illustrated in FIGS. 2a-2b.

Referring now to FIG. 3b, an embodiment of a directional link chain 303 is illustrated. Directional link chain 303 comprises a directional indication element 304. Directional indication element 304 consists of a square shape material having a negative indication space 305 configured to indicate the direction of travel of directional link chain 303 during operation in a chain fall, chain hoist, roll-up garage door, chain trolley hoist, or other hand crank chain system.

Referring now to FIG. 3c, an embodiment of a directional link chain 306 is illustrated. Directional link chain 306 comprises a first U-shaped end 307, a second U-shaped end 308, and directional indication element 309 positioned adjacent to a bottom portion 310 of second U-shaped end 308.

Referring now to FIG. 3d, an embodiment of a directional link chain 311 is illustrated. Directional link chain 311 comprises a U-shaped end 312 and directional indication element 313 positioned adjacent to a bottom portion 314 of U-shaped end 312.

Referring now to FIG. 4, a series of interconnected directional links 400 for use in a vertical chain fall or roll-up garage door 403 is illustrated. According to an embodiment, each directional link chain 401 of the series of interconnected directional links comprises a directional indication element 402 having a vertical indication corresponding to a directionality of load travel during operation in vertical chain fall 403. Specifically, during operation, a user or multiple users pull the series of interconnected directional links connected to a gear system in vertical chain fall 403 enabling lifting chain 404 and an attached load via hook 405 to be moved vertically, i.e. up or down. The directional indication elements of each directional link chain of the series of interconnected directional links enable the user or multiple users to visually recognize the gear system direction, and corresponding load direction via the up or down indication displayed via each directional indication element to efficiently move the load the desired direction without trial and error. For instance, if a user desires to move the attached load in a vertically downward direction, the user would pull on the series of interconnected directional links having directional indication elements indicating a downward direction. Alternatively, if a user desires to move the attached load in a vertically upward direction, the user would pull on the series of interconnected directional links having directional indication elements indicating an upward direction. Directional link chain 401 may be any directional link chain described above and illustrated in FIGS. 2a-3d.

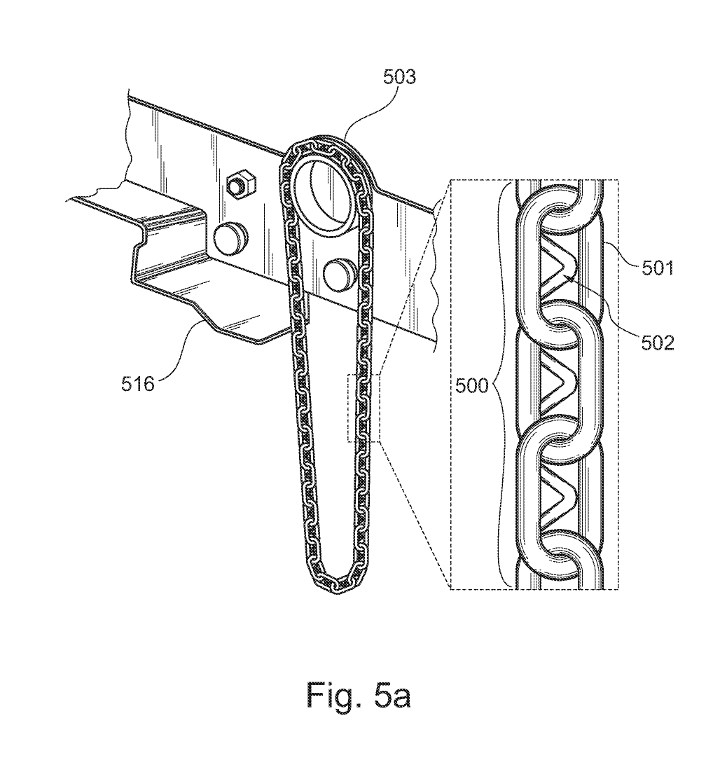

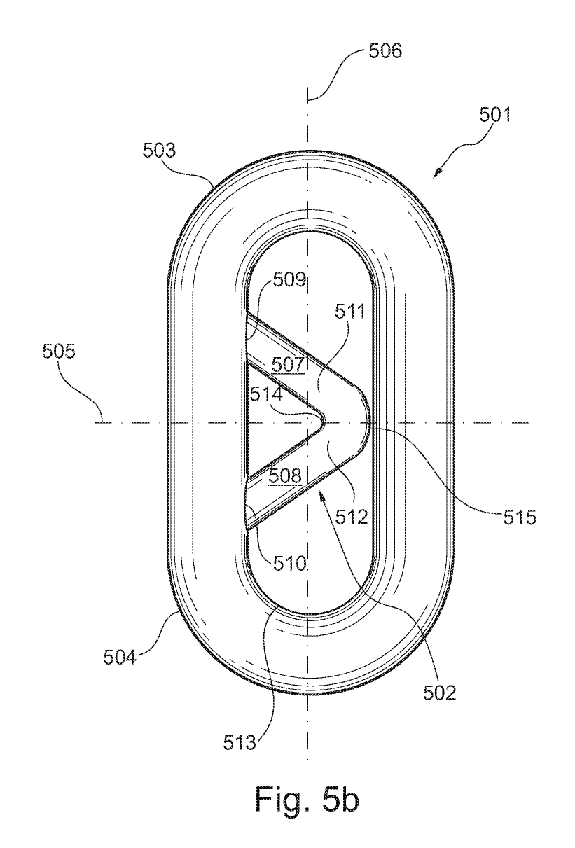

Referring now to FIG. 5a, a series of interconnected directional links 500 for use in a horizontal chain fall or roll-up garage door 503 is illustrated. According to an embodiment, each directional link chain 501 of the series of interconnected directional links comprises a directional indication element 502 having a horizontal indication corresponding to a directionality of travel during operation in horizontal chain fall 503. In the exemplary embodiment illustrated, horizontal chain fall 503 is a trolley hoist. During operation, a user or multiple users pull the series of interconnected directional links connected to a gear system in horizontal chain fall 503 enabling trolley 516 (with or without an attached load) to be moved horizontally, i.e. left or right. For the purpose of this disclosure, trolley 516 can be referred to as a load.

The directional indication elements of each directional link chain of the series of interconnected directional links enable the user or multiple users to visually recognize the gear system direction, and corresponding trolley direction via the left or right indication displayed via each directional indication element to efficiently move the trolley the desired direction without trial and error. For instance, if a user desires to move the trolley in a horizontally leftward direction, the user would pull on the series of interconnected directional links having directional indication elements indicating a leftward direction. Alternatively, if a user desires to move the trolley in a horizontally rightward direction, the user would pull on the series of interconnected directional links having directional indication elements indicating a rightward direction.

Referring now to FIG. 5b, directional link chain 501 is illustrated. According to an embodiment, directional link chain 501 comprises a first U-shaped end 503 and a second U-shaped end 504 opposed at a transverse plane 505, such that the first U-shaped end is above the transverse plane, and the second U-shaped end is below the plane. First U-shaped end 503 and second U-shaped end 504 form an integral link chain configured to be interconnected to a series of interconnected directional links 500 (FIG. 5a). In an embodiment, first U-shaped end 503 and second U-shaped end 504 are symmetric to a longitudinal axis 506.

As previously described, directional link chain 501 comprises a directional indication element 502, the directional indication element consisting of a pair of directional members 507/508, each directional member having a proximal end 509/510 and a distal end 511/512. In an embodiment, the proximal end of each directional member is attached to an interior surface 513 of the integral link chain. The distal ends of each directional member are combined to form a left indication point 514 and a right indication point 515, such that a horizontal plane intersecting the left indication point and the right indication point is parallel to transverse plane 505.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

1. A directional link chain for use in chain wheel operators comprising:
a series of interconnected directional links, each directional link comprising a first U-shaped end and a second U-shaped end forming an integral link chain, wherein the first and second U-shaped ends are opposed at a transverse plane and symmetric to a longitudinal axis; and,
a directional indication element consisting of a V-shaped member extending from the second U-shaped end of each directional link and terminating at a point to define a directional indication element, the directional indication element corresponding to a directionality of travel of a load in a chain wheel operator.

2. The directional link chain of claim 1, wherein the at least one indication point is positioned along the longitudinal axis.

3. The directional link chain of claim 2, further comprising a pair of directional members being positioned symmetrically in relation to the longitudinal axis, such that the pair of directional members forms a pair of equal acute angles from the longitudinal axis.

4. The directional link chain of claim 1, wherein the at least one indication point includes a first indication point and a second indication point, the first indication point being positioned approximate to the transverse plane.

5. The directional link chain of claim 3, wherein the proximal end of each directional member is attached to an interior surface of the integral link chain.

6. The directional link chain of claim 1, wherein the chain wheel operator is configured to move a load vertically.

7. The directional link chain of claim 1, wherein the at least one indication point includes a first lateral indication point and a second lateral indication point, such that a horizontal plane intersecting the first lateral indication point and the second lateral indication point is parallel to the transverse plane.

8. The directional link chain of claim 7, wherein the chain wheel operator is configured to move a load horizontally.

9. A directional link chain for use in chain wheel operators comprising:
a plurality of interconnected directional links, each directional link in the plurality of interconnected directional links comprising at least one U-shaped end; and,
a V-shaped directional indication element having at least one indication point, the V-shaped directional indication element corresponding to a directionality of travel of a load, the V-shaped directional indication element extending from a distal end of each directional link in the plurality of interconnected directional links and terminating at a point.

10. The directional link chain of claim 9, wherein the at least one U-shaped end is a first U-shaped end and a second U-shaped end, wherein the first and second U-shaped ends are opposed at a transverse plane and symmetric to a longitudinal axis, and the V-shaped directional indication element is adjacent to a distal portion of the second U-shaped end.

11. The directional link chain of claim 9, wherein the V-shaped directional indication element is adjacent to a distal portion of the at least one U-shaped end.
